(19) United States
(12) Patent Application Publication
(10) Pub. No.: US 2007/0082311 A1
(43) Pub. Date: Apr. 12, 2007

(54) METHOD FOR CONTROLLING HEATING APPARATUS

(75) Inventors: Takahito Yamaguchi, Saitama (JP); Kiyoshi Dozono, Saitama (JP)

Correspondence Address: DARBY & DARBY P.C., P. O. BOX 5257, NEW YORK, NY, 10150-5257, US

(73) Assignees: TAMURA CORPORATION, Nerima-ku (JP); TAMURA FA SYSTEM CORPORATION, Sayama-shi (JP)

(21) Appl. No.: 11/532,345

(22) Filed: Sep. 15, 2006

(30) Foreign Application Priority Data
Sep. 16, 2005 (JP) 2005-269820

(51) Int. Cl. F26B 11/02

(52) U.S. Cl. 432/1

(57) ABSTRACT

A method for controlling a heating apparatus whereby the heating apparatus is started up effectively with limited power consumption. A heating priority is determined by multiplying the temperature deviation in each zone by a heat capacity coefficient specific for each zone. The heating priority of each zone is determined alternatively by multiplying an adjacency temperature deviation between adjacent zones by an adjacency coefficient that is set based on the adjacency relationship. The order of zones from the highest to lowest heating priorities is determined, and a plurality of zones are combined in such a manner as to include ones having, respectively, the highest and lowest heating priorities to prepare a group. Similarly, other plurality of zones are combined to prepare groups repeatedly. The power consumption of heaters is limited in each of these groups.

### INCORPORATION BY REFERENCE

The present application claims priority under 35 U.S.C. §119 to Japanese Patent Application No. 2005-269820 filed on Sep. 16, 2005. The content of the application is incorporated herein by reference in its entirety.

### FIELD OF THE INVENTION

The present invention relates to a method for controlling a heating apparatus used as, for example, a reflow furnace or a heat-hardening furnace.

### BACKGROUND OF THE INVENTION

In methods for controlling a heating apparatus such as a reflow furnace, supplying maximum power simultaneously to a plurality of heaters provided in the furnace at the start-up of the apparatus allows the heating apparatus to be started up in a short period of time, but there is a possibility that the power consumption at the start-up of the apparatus exceeds the limit of the plant's power system, resulting in a disruption in power supply.

Hence, there has been proposed a method for starting heaters in which the start-up time of the heaters is measured preliminarily through an experiment, and the time through which the current consumption of each heater decreases and becomes equal to or smaller than a certain value with an increase in temperature of the heaters is stored in a control section, and then the heaters are started up sequentially while delaying the start-up time thereof at an interval defined by the time stored (e.g. see Japanese Patent No. 2885047 (Pages 2 to 3 and FIG. 5)).

Even in such a method for controlling a heating apparatus in which heaters are started up sequentially at a time interval that is obtained preliminarily through an experiment, there is a possibility that in the case of an environmental variation that is not assumed in the experiment, the second to-be-started heater starts to be supplied with power while the first to-be-started heater is not completely started up and still has a large consumption current, which may result in a disruption in power supply.

### SUMMARY OF THE INVENTION

The present invention has been made in consideration of the above-described problem, and an object thereof is to provide a method for controlling a heating apparatus whereby the heating apparatus can be started up effectively with limited power consumption.

The present invention is a method for controlling a heating apparatus adapted to start heaters that are provided, respectively, in a plurality of zones arranged along a conveyor for conveying a work in a furnace body, the method comprising the steps of: preparing a plurality of groups by combining a plurality of zones including ones having, respectively, high and low heating priorities; and limiting the power consumption of heaters in each group. Since the power consumption of heaters is limited in each group that is prepared by combining a plurality of zones including ones having, respectively, high and low heating priorities, the heating apparatus can be started up effectively by making effective use of limited power consumption.

In the present invention, the method for controlling the heating apparatus is arranged in such a manner that the preparation of the groups is performed by: determining the order of zones from the highest to lowest heating priorities; and combining two or more zones including one having the highest heating priority or a priority close thereto and one having the lowest heating priority or a priority close thereto and repeating to combine two or more zones including one having the highest heating priority or a priority close thereto and one having the lowest heating priority or a priority close thereto among the remaining zones. Since two or more zones including one having the highest heating priority or a priority close thereto and one having the lowest heating priority or a priority close thereto are combined and two or more similar zones among the remaining zones are combined repeatedly, it is possible to prepare an efficient combination of zones for each group and thereby to limit the power consumption of heaters in each group, whereby the heating apparatus can be started up effectively by making full use of limited power consumption.

In the present invention, the method for controlling the heating apparatus is arranged in such a manner that the heating priority is determined based on the temperature deviation between the set temperature and the present temperature of each zone. Since the heating priority is determined based on the temperature deviation between the set temperature and the present temperature of each zone, combining a plurality of zones including ones having, respectively, large and small temperature deviations makes it possible to start the heating apparatus effectively by making effective use of limited power consumption.

In the present invention, the method for controlling the heating apparatus is arranged in such a manner that the heating priority is determined by multiplying the temperature deviation between the set temperature and the present temperature of each zone by the heat capacity coefficient set for each zone. Multiplying the temperature deviation in each zone by the heat capacity coefficient makes it possible to determine the order of the heating priority and the combination of zones based on the order precisely while adding the heat capacity specific for each zone, that is, the ease and difficulty in heating the zones to the temperature deviation.

In the present invention, the method for controlling the heating apparatus is arranged in such a manner that the heat capacity coefficient is set greater for zones nearer inlet and outlet ports for conveying a work therethrough into and out of the furnace body, while being set smaller for zones nearer the center of the furnace body. Since the heat capacity coefficient is set greater for zones nearer the inlet and outlet ports of the furnace body, while being set smaller for zones nearer the center of the furnace body, it is possible to determine appropriate heating priorities for zones where the temperature is less likely to be increased due to leakage of heated atmosphere outward through the inlet and outlet ports of the furnace body.

In the present invention, the method for controlling the heating apparatus is arranged in such a manner that the heat capacity coefficient is set greater for zones formed below the conveyor than zones formed above the conveyor. Since the heat capacity coefficient is set greater for zones below the conveyor than zones above the conveyor, it is possible to determine appropriate heating priorities for the lower zones where the temperature is less likely to be increased due to a rise in heated atmosphere from below to above.

In the present invention, the method for controlling the heating apparatus is arranged in such a manner that the heating priority is determined through a calculation using the adjacency coefficient that is set based on the adjacency relationship between side-to-side and above-to-below adjacent zones. It is possible to determine the order of the heating priority and the combination of zones based on the order more precisely while adding the heat capacity specific for each zone and further the adjacency relationship between side-to-side and above-to-below adjacent zones to the temperature deviation based, respectively, on the heat capacity coefficient and the adjacency coefficient.

In the present invention, the method for controlling the heating apparatus is arranged in such a manner that the preparation of the groups is modified automatically with at least one of either the change in temperature in each zone or the passage of time. Since the combination of a plurality of zones is modified automatically with at least one of either the change in temperature in each zone under a start-up operation or the passage of time, it is possible to address changing situations and/or environmental variations efficiently during a start-up operation from the start of the start-up through the start of a main heating operation, whereby the time required for the start-up operation can be shortened.

In the present invention, the method for controlling the heating apparatus is arranged in such a manner that the power consumption of the heaters is limited by controlling heaters exclusively on and off in a plurality of zones in each group. Controlling a plurality of combined heaters exclusively on and off makes it possible to limit the power consumption for digital control of the heaters efficiently.

In the present invention, the method for controlling the heating apparatus is arranged in such a manner that the power consumption of the heaters is limited by controlling the output of heaters to be 100% in total in a plurality of zones in each group. Controlling the output of heaters to be 100% in total in a plurality of zones in each group makes it possible to limit the power consumption for analog control of the heaters efficiently.

### BRIEF DESCRIPTION OF THE DRAWINGS

FIG. 1 is a flow chart showing a method for controlling a heating apparatus according to an embodiment of the present invention;

FIG. 2 is a schematic view of the heating apparatus;

FIG. 3 is a timing chart for controlling heaters on and off showing a specific example of the method for controlling the heating apparatus;

FIG. 4 is a timing chart for controlling heaters on and off showing another specific example of the method for controlling the heating apparatus; and

FIG. 5 is a view showing time-temperature and time-power consumption curves according to the method for controlling the heating apparatus.

### DETAILED DESCRIPTION OF THE PREFERRED EMBODIMENT

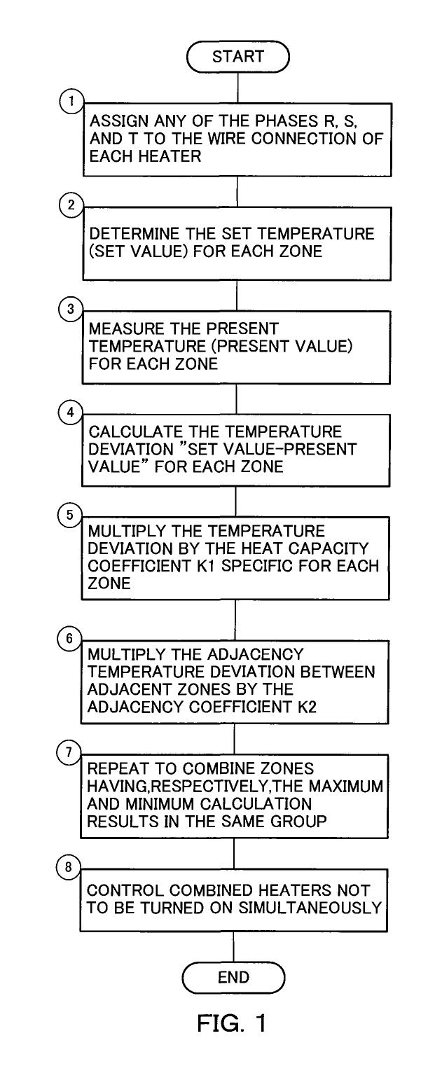

The present invention will hereinafter be described in detail with reference to an embodiment shown in FIGS. 1 to 5.

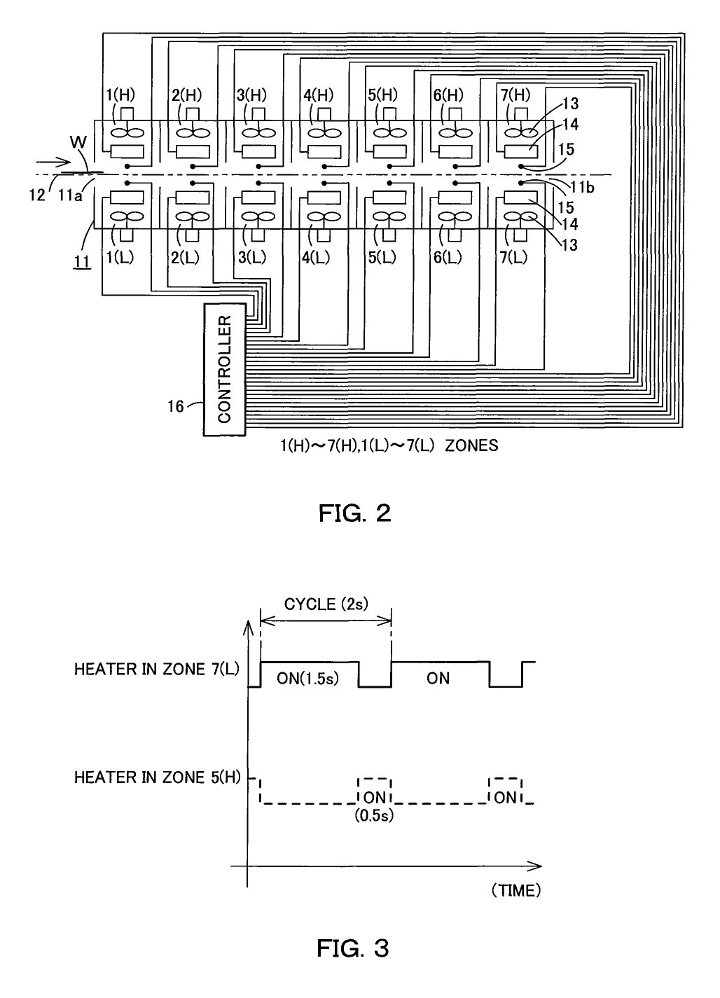

FIG. 2 shows a heating apparatus for reflow soldering, in which a conveyor 12 for conveying a printed circuit board with electronic parts mounted thereon via soldering paste (this electronic parts mounted board will hereinafter be referred to as “work W”) is disposed in such a manner as to penetrate through a furnace body 11. The conveyor 12 is adapted to convey the work W into the furnace body 11 through the inlet port 11a thereof, through the furnace body 11, and out of the furnace body 11 through the outlet port 11b thereof.

Between the inlet and outlet ports 11a and 11b in the furnace body 11, a plurality of zones 1, 2, 3, 4, 5, 6, and 7 formed sectionally by partition walls are arranged along the conveyor 12. The zones 1, 2, 3, 4, 5, 6, and 7 are classified into a group of zones 1 (H), 2 (H), 3 (H), 4 (H), 5 (H), 6 (H), and 7 (H) that are formed above the conveyor 12 and another group of zones 1 (L), 2 (L), 3 (L), 4 (L), 5 (L), 6 (L), and 7 (L) that are formed below the conveyor 12. The zones 1 (H) to 5 (H) and 1 (L) to 5 (L) are preheat zones and the zones 6 (H), 7 (H), 6 (L), and 7 (L) are reflow zones.

In each of the zones 1 (H) to 7 (H) and 1 (L) to 7 (L), there is provided a fan 13 for circulating atmosphere in each zone, a heater 14 for heating atmosphere in each zone, and a temperature sensor 15 for detecting the temperature of atmosphere in each zone.

The heaters 14 and temperature sensors 15 are connected to a controller 16 for controlling power supply to each heater 14 while monitoring the temperature of atmosphere in each zone. The controller 16 is adapted to control a start-up operation for setting up the temperature of atmosphere in the zones 1 (H) to 7 (H) and 1 (L) to 7 (L) before starting a main heating operation, and to control the temperature of atmosphere in the zones 1 (H) to 7 (H) and 1 (L) to 7 (L) to be kept at a predetermined preheat temperature or reflow temperature during the main heating operation.

As a control method by which the controller 16 controls each heater 14, there may suitably be employed, for example, a pulse-width modulation method (so-called PWM method) or a pulse-frequency modulation method (so-called PFM method) in which a switching circuit is controlled based on temperature information from each temperature sensor 15 to control the heater-on duty ratio (=on-time/switching cycle).

A control method by the controller 16 when starting the heating apparatus thus having the plurality of zones 1 (H) to 7 (H) and 1 (L) to 7 (L) for heating by the respective heaters 14 is described in the following with reference to the flow chart shown in FIG. 1. It is noted that in FIG. 1, the circled numbers represent step numbers that indicate the control procedure.

(Step 1)

The wire connection of each heater 14 for each of the zones 1 (H) to 7 (H) and 1 (L) to 7 (L) is assigned among any of three phases (R, S, and T) to obtain a balance between the phases.

(Step 2)

The set temperatures (set values) SV1H, SV1L, . . . SV7H, and SV7L are determined for each of the zones 1 (H) to 7 (H) and 1 (L) to 7 (L).

(Step 3)

The present temperatures (present values) PV1H, PV1L, . . . PV7H, and PV7L are measured for each of the zones 1 (H) to 7 (H) and 1 (L) to 7 (L).

(Step 4)

The temperature deviations Z1H, Z1L, . . . Z7H, and Z7L between the set temperatures and the present temperatures (set values−present values) are calculated for each of the zones 1 (H) to 7 (H) and 1 (L) to 7 (L).
Z1H=SV1H−PV1H
Z1L=SV1L−PV1L
. . .
. . .
. . .
Z7H=SV7H−PV7H
Z7L=SV7L−PV7L

The order of zones from the highest to lowest heating priorities may be determined based on the order of zones from the maximum to minimum temperature deviations among the temperature deviations Z1H, . . . Z1L, Z7H, and Z7L for each of these zones 1 (H) to 7 (H) and 1 (L) to 7 (L).

However, in the present embodiment, the order of the heating priority is determined in the following Step 5 in consideration that each of the zones 1 (H) to 7 (H) and 1 (L) to 7 (L) have their respective specific heat capacities.

(Step 5)

Even if each of the zones 1 (H) to 7 (H) and 1 (L) to 7 (L) may be supplied with the same amount of thermal energy, the temperature of the zones nearer the center of the furnace body 11 is more likely to be increased, while the temperature of the zones nearer the inlet and outlet ports 11a and 11b of the furnace body 11 is less likely to be increased than that of the zones in the center of the furnace body 11, that is, having a large heat capacity. Also, the temperature of the zones 1 (L) to 7 (L) below the conveyor 12 is less likely to be increased than that of the zones 1 (H) to 7 (H) above the conveyor 12, that is, having a large heat capacity. In consideration of these points, the heat capacity specific for each of the zones 1 (H) to 7 (H) and 1 (L) to 7 (L) is summarized preliminarily in a matrix to set the heat capacity coefficient K1.

That is, as shown in Table 1 below, the heat capacity coefficient K1 is set greater for zones nearer the inlet and outlet ports 11a and 11b, and set smaller for zones nearer the center of the furnace body 11, and further is set greater for the lower zones 1 (L) to 7 (L) than the upper zones 1 (H) to 7 (H).

Subsequently, the heating priority is determined by multiplying the temperature deviations Z1H, Z1L, . . . Z7H, and Z7L for each of the zones 1 (H) to 7 (H) and 1 (L) to 7 (L) by the heat capacity coefficient K1 set specifically for each of the zones 1 (H) to 7 (H) and 1 (L) to 7 (L). The greater the multiplication result, the higher is the heating priority.

TABLE 1
Heat capacity coefficient K1

| | Zone | Zone | Zone | Zone | Zone | Zone | Zone |
|---|---|---|---|---|---|---|---|
| | 1 | 2 | 3 | 4 | 5 | 6 | 7 |
| Upper (H) | 1.3 | 1.1 | 1.0 | 1.0 | 1.0 | 1.2 | 1.5 |
| Lower (L) | 1.4 | 1.2 | 1.1 | 1.1 | 1.1 | 1.3 | 1.6 |

Examples of calculations in Steps 2, 3, 4, and 5 are shown in Table 2 below. The circled numbers in Table 2 correspond to the step numbers.

TABLE 2
Examples of calculations

| | | Zone 1 | Zone 2 | Zone 3 | Zone 4 | Zone 5 | Zone 6 | Zone 7 |
|---|---|---|---|---|---|---|---|---|
| \textcircled{2} | SV (Upper) | 160 | 150 | 150 | 150 | 150 | 245 | 225 |
| | SV (Lower) | 160 | 150 | 150 | 150 | 150 | 245 | 225 |
| \textcircled{3} | PV (Upper) | 30 | 30 | 30 | 30 | 30 | 30 | 30 |
| | PV (Lower) | 30 | 30 | 30 | 30 | 30 | 30 | 30 |
| \textcircled{4} | SV − PV (Upper) | 130 | 120 | 120 | 120 | 120 | 215 | 195 |
| | SV − PV (Lower) | 130 | 120 | 120 | 120 | 120 | 215 | 195 |
| \textcircled{5} | Calculation | 169 | 132 | 120 | 120 | 120 | 258 | 293 |
| | results (Upper) | | | | | | | |
| | Calculation | 182 | 144 | 132 | 132 | 132 | 280 | 312 |
| | results (Lower) | | | | | | | |

(Step 6)

If it is difficult to determine the heating priority in Step 5, for example, if multiplication results are the same as or approximate to each other, the heating priority of each zone is determined alternatively by multiplying the adjacency temperature deviation between side-to-side and above-to-below adjacent zones by the adjacency coefficient K2 that is set based on the adjacency relationship.

That is, the heating priority is determined by calculating the temperature deviations Z1H, Z1L, . . . Z7H, and Z7L between the set temperatures and the present temperatures (set values—present values) for each of the zones 1 (H) to 7 (H) and 1 (L) to 7 (L) and the temperature deviations ZOH, ZOL, Z1H, Z1L, . . . Z7H, Z7L, Z8H, and Z8L between the set temperatures and the present temperatures in zones adjacent to each of the zones 1 (H) to 7 (H) and 1 (L) to 7 (L), and multiplying the adjacency temperature deviations, the differences between the temperature deviations Z1H, Z1L, . . . Z7H, and Z7L for each of the zones 1 (H) to 7 (H) and 1 (L) to 7 (L) and the temperature deviations ZOH, ZOL, Z1H, Z1L, . . . Z7H, Z7L, Z8H, and Z8L in the adjacent zones by the adjacency coefficient K2 that is set based on the adjacency relationship (e.g. K2=0.5 for side-to-side, K2=0.8 forabove-to-below), and then calculating the summation Y1H, Y1L, . . . Y7H, and Y7L of multiplication results for each adjacency relationship for each of the zones 1 (H) to 7 (H) and 1 (L) to 7 (L), as represented by the following formulae shown below.

It is noted that Z0H and Z0L are the temperature deviations between the set temperatures and the present temperatures in outside zones on the side of the inlet port 11a of the furnace body 11, while Z8H and Z8L are the temperature deviations between the set temperatures and the present temperatures in outside zones on the side of the outlet port 11b of the furnace body 11, and that Z0H, Z0L, Z8H, and Z8L, which are nonexistent zones, are assigned with virtual values.
Y1H=(Z0H−Z1H)×0.5+(Z2H−Z1H)0.5+(Z1L−Z1H)×0.8
Y1L=(Z0L−Z1L)×0.5+(Z2L−Z1L)×0.5+(Z1H−Z1L)×0.8
. . .
. . .
. . .
Y7H=(Z6H−Z7H)×0.5+(Z8H−Z7H)×0.5+(Z7L−Z7H)×0.8
Y7L=(Z6L−Z7L)×0.5+(Z8L−Z7L)×0.5+(Z7H−Z7L)×0.8

Thus multiplying the adjacency temperature deviations, the differences between the temperature deviations for each of the zones 1 (H) to 7 (H) and 1 (L) to 7 (L) and the temperature deviations in the adjacent zones by the adjacency coefficient K2 makes it possible to determine the order of the heating priority and the combination of zones based on the order precisely while adding reciprocal effects with adjacent zones to the corresponding zones.

(Step 7)

After the order of zones from the highest to lowest heating priorities is determined through the calculations in Steps 5 and 6, zones having, respectively, the highest and lowest heating priorities are combined to prepare a group, and zones having, respectively, the highest and lowest heating priorities among the remaining zones are combined repeatedly to prepare groups. An example of combination results is shown in Table 3 below. Two zones form one group, where one having the higher heating priority is referred to as master (prioritized), while the lower is referred to as slave (non-prioritized).

TABLE 3
Combination results (1)

| | | | | | | | |
|---|---|---|---|---|---|---|---|
| Master | Zone | Zone | Zone | Zone | Zone | Zone | Zone |
| (prioritized) | 7 (L) | 7 (H) | 6 (L) | 6 (H) | 1 (L) | 1 (H) | 2 (L) |
| Slave | Zone | Zone | Zone | Zone | Zone | Zone | Zone |
| (non-prioritized) | 5 (H) | 3 (H) | 4 (H) | 2 (H) | 5 (L) | 3 (L) | 4 (L) |

* (L) and (H) mean, respectively, lower and upper.

(Step 8)

The time ratio of “on” output is distributed for two heaters 14, 14 in the thus combined each group to limit the power consumption of the heaters. For example, the heaters 14, 14 in the zones 7 (L) and 5 (H) combined as shown in Table 3 are controlled exclusively on and off to limit the power consumption of the heaters.

In a control method for controlling the temperature of the heaters 14, 14 in the combined group using a pulse adapted to energize the heaters at a constant cycle (e.g. 2 seconds), the above-described exclusive on-off control employs time slicing so as to avoid redundant “on” between the heaters 14, 14 in the combined zones 7 (L) and 5 (H), that is, so as not to transmit pulses simultaneously to the respective heaters.

For example, as shown in FIG. 3, if turning the heater 14 in the zone 7 (L) on for 1.5/2 seconds, the heater 14 in the zone 5 (H) is controlled to be off for the same number of seconds, while if turning the heater 14 in the zone 7 (L) off for 0.5/2 seconds, the heater 14 in the zone 5 (H) is controlled to be on for the same number of seconds, so that one pair of heaters 14, 14 constantly consumes a predetermined power in total, resulting in an efficient operation.

The time ratio of “on” output to be distributed for heaters 14, 14 in one combined group is determined based on the heating priority ratio for each combined group. For example, in the group of combined zones 2 (L) and 4 (L), since the heating priority ratio is close to 1, the time ratio of “on” out put to be distributed for the heaters 14, 14 is controlled automatically to be also close to 1.

It is noted that although groups are prepared by combining a plurality of zones including ones having, respectively, high and low heating priorities, each group is not restricted to a combination of two zones, but may be prepared by combining three or more zones.

To describe an example of preparing each group from three zones for example, zones having, respectively, the highest and lowest heating priorities are combined repeatedly to prepare groups, as is the case in Table 3 and the summation of the heating priorities of the master and slave (Calculation results (Upper) and (Lower) in Table 2) is calculated for each group, and then the four zones included in the two minimum groups on the summation results in descending order of the heating priority, that is, in order of zones 1 (H), 2 (L), 4 (L), and 3 (L) are assigned to the remaining groups in ascending order of the summation of the heating priorities, whereby groups each including three combined zones are prepared as shown in Table 4.

TABLE 4
Combination results (2)

| | | | | | |
|---|---|---|---|---|---|
| Master | Zone 7 (L) | Zone 7 (H) | Zone | Zone | Zone |
| (prioritized) | | | 6 (L) | 6 (H) | 1 (L) |
| Slave | Zone 5 (H) | Zone 3 (H) | Zone | Zone | Zone |
| (non-prioritized) | | | 4 (H) | 2 (H) | 5 (L) |
| Slave | | Zone 3 (L) | Zone | Zone | Zone |
| (non-prioritized) | | | 4 (L) | 2 (L) | 1 (H) |

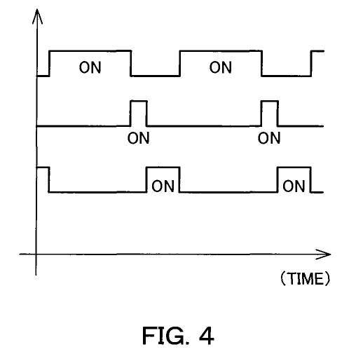

FIG. 4 shows a case where a group is prepared by combining three zones having, respectively, the highest, lowest, and middle heating priorities as mentioned above, in which the on-off waveforms are controlled for the heaters 14, 14, 14 in the three zones having, respectively, the highest, lowest, and middle heating priorities as indicated in the respective upper, middle, and lower parts.

Further, in the case of preparing a group by combining a plurality of zones, not only two or more zones including ones having, respectively, the highest and lowest heating priorities but also [:], two or more zones including ones having, respectively, the highest heating priority and a priority close to the lowest (e.g. one having not the lowest priority but close thereto after a calculation using the heat capacity coefficient K1 in Step 5 and having the lowest priority after a calculation using the adjacency coefficient K2 in Step 6); two or more zones including ones having, respectively, a priority close to the highest (e.g. one having not the highest priority but close thereto after a calculation using the heat capacity coefficient K1 in Step 5 and having the highest priority after a calculation using the adjacency coefficient K2 in Step 6) and the lowest heating priority; or two or more zones including ones having, respectively, priorities close to the highest and lowest heating priorities may be combined.

Also, the limitation in the power consumption of each heater is not restricted to such a digital control method as mentioned above in which heaters in a plurality of zones in each group are controlled exclusively on and off, but may be based on an analog control method in which the output for heaters in a plurality of zones in each group is controlled to be 100% in total, and the output for heaters is changed depending on time and temperature within the limitation, whereby the power consumption of heaters is limited in each group.

To describe specifically, in the case of changing the digital control method shown in FIG. 4 to an analog control method, it is preferable that the zones having, respectively, the highest, lowest, and middle heating priorities be controlled to consume, for example, 60%, 10%, and 30% of the power that is assigned to the group.

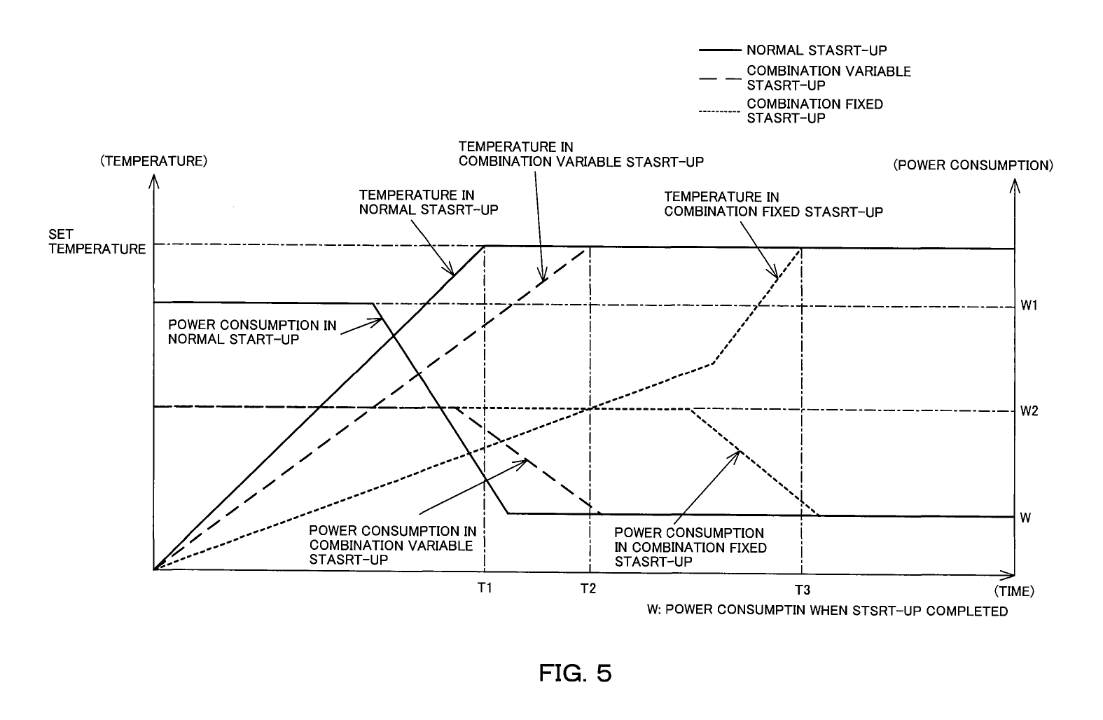

FIG. 5 shows average time-temperature and time-power consumption curves for each of the zones 1 (H) to 7 (H) and 1 (L) to 7 (L), and the cases of the power consumption W2 where heaters in a plurality of zones that are combined in Step 7 are started up by the control method in Step 8 as indicated by the coarse and fine dashed lines in FIG. 5 allow the heaters to consume less power than the case of the power consumption W1 in a normal start-up where a heater in each zone is supplied with power according to the temperature deviation between the set temperature and the present temperature as indicated by the solid line in FIG. 5.

Further, combining a plurality of zones in Step 7 includes: the case where the combination of zones calculated by the controller 16 in Step 7 is fixed immediately before the start of a heater start-up operation (indicated by the fine dashed line in FIG. 5); and the case where in a heater start-up operation, the controller 16 automatically performs the calculation of the flow chart shown in FIG. 1 again for each change in the temperature of each zone by a predetermined value or more and for each predetermined time, and when the order of the heating priority is changed, the combination of zones in Step 7 is modified automatically depending on the change (indicated by the coarse dashed line in FIG. 5). Comparing these cases shows that the time T2 required for start-up completion in the case where the combination of zones is modified automatically with at least one of either the change in temperature in each zone or the passage of time (indicated by the coarse dashed line) can be made shorter than the time T3 required for start-up completion in the case where the combination of zones is fixed (indicated by the fine dashed line).

That is, in the case of a normal heater start-up operation, the start-up operation can be completed in a short period of time but the power consumption during the start-up operation is increased. Also, in the case of a zone combination fixed start-up operation, the power consumption during the start-up operation can be reduced. Further, in the case of a zone combination variable start-up operation, not only can the power consumption during the start-up operation be reduced, but also the time required for the start-up operation can be shortened.

Effects of the present embodiment are described in the following.

Since the power consumption of heaters is limited in each group that is prepared by combining a plurality of zones including ones having, respectively, high and low heating priorities, the heating apparatus can be started up effectively by making effective use of limited power consumption.

Since two or more zones including one having the highest heating priority or a priority close thereto and one having the lowest heating priority or a priority close thereto are combined and two or more similar zones among the remaining zones are combined repeatedly, it is possible to prepare an efficient combination of zones for each group and thereby to limit the power consumption of heaters in each group, whereby the heating apparatus can be started up effectively by making full use of limited power consumption.

For example, since the zones 7 (L) and 5 (H) having, respectively, the highest and lowest heating priorities, which are determined in Steps 5 and 6, are combined, and then the zones 7 (H) and 3 (H) having, respectively, the highest and lowest heating priorities among the remaining zones, then 6 (L) and 4 (H), then 6 (H) and 2 (H), then 1 (L) and 5 (L), then 1 (H) and 3 (L), then 2 (L) and 4 (L) are combined repeatedly to search out zones requiring a larger amount of heat and zones requiring a smaller amount of heat automatically, it is possible to prepare efficient combinations of zones for heating and thereby to limit the power consumption of heaters 14, 14 in these combinations, whereby the heating apparatus can be started up effectively by making full use of limited power consumption.

Since the heating priorities are determined based on the temperature deviations Z1H, Z1L, . . . Z7H, and Z7L between the set temperatures SVLH, SVlL, . . . SV7H, and SV7L and the present temperatures PVlH, PVlL, . . . PV7H, and PV7L for each of the zones 1 (H) to 7 (H) and 1 (L) to 7 (L), combining a plurality of zones including ones having, respectively, large and small temperature deviations makes it possible to start the heating apparatus effectively by making effective use of limited power consumption.

Multiplying the temperature deviations Z1H, Z1L, . . . Z7H, and Z7L between the set temperatures SVLH, SVlL,. . . SV7H, and SV7L and the present temperatures PVlH, PVlL, . . . PV7H, and PV7L of the zones 1 (H) to 7 (H) and 1 (L) to 7 (L) by the heat capacity coefficient K1 makes it possible to determine the order of the heating priority and the combination of zones based on the order precisely while adding the heat capacity specific for each of the zones 1 (H) to 7 (H) and 1 (L) to 7 (L), that is, the ease and difficulty in heating the zones to the temperature deviations.

Since the heat capacity coefficient K1 is set greater for zones nearer the inlet and outlet ports 11a and 11b of the furnace body 11, while being set smaller for zones nearer the center of the furnace body 11, it is possible to determine appropriate heating priorities for zones where the temperature is less likely to be increased due to leakage of heated atmosphere outward through the inlet and outlet ports 11a and 11b of the furnace body 11.

Since the heat capacity coefficient K1 is set greater for the zones 1 (L) to 7 (L) below the conveyor 12 than the zones 1 (H) to 7 (H) above the conveyor 12, it is possible to determine appropriate heating priorities for the lower zones 1 (L) to 7 (L) where the temperature is less likely to increase due to a rise in heated atmosphere from below to above.

Adding the heat capacity specific for each of the zones 1 (H) to 7 (H) and 1 (L) to 7 (L) to the temperature deviations Z1H, Z1L, . . . Z7H, and Z7L based on the heat capacity coefficient K1 and multiplying the adjacency temperature deviations, the differences between the temperature deviations Z1H, Z1L, . . . Z7H, and Z7L for each of the zones 1 (H) to 7 (H) and 1 (L) to 7 (L) and the temperature deviations Z0H, Z0L, Z1H, Z1L, . . . Z7H, Z7L, Z8H, and Z8L in the adjacent zones by the adjacency coefficient K2 makes it possible to determine the order of the heating priority and the combination of zones based on the order precisely while adding reciprocal effects with adjacent zones to the corresponding zones.

Controlling a plurality of combined heaters exclusively on and off as shown in FIGS. 3 and 4 makes it possible to limit the power consumption for digital control of the heaters efficiently. In this case, in a control method for controlling the temperature of a plurality of heaters using a pulse at a constant cycle, employing time slicing so as to avoid redundancy due to simultaneous “on” between the plurality of combined heaters allows the power consumption of the heaters to be limited easily.

Since the combination of a plurality of zones is modified automatically with at least one of either the change in temperature in each zone under a start-up operation or the passage of time as indicated by the coarse dashed line in FIG. 5, it is possible to address changing situations and/or environmental variations efficiently during a start-up operation from the start of the start-up through the start of a main heating operation, whereby the time required for the start-up operation can be shortened. That is, the temperature of the furnace body 11 can be increased effectively in a relatively short period of time.

Also, controlling the output of heaters to be 100% in total in a plurality of zones in each group makes it possible to limit the power consumption for analog control of the heaters efficiently.

The present invention is applicable as a method for controlling a heating apparatus such as a reflow furnace for reflow soldering or a heat-hardening furnace for thermosetting resin.

1. A method for controlling a heating apparatus adapted to start heaters that are provided, respectively, in a plurality of zones arranged along a conveyor for conveying a work in a furnace body, the method comprising the steps of:
preparing a plurality of groups by combining a plurality of zones including ones having, respectively, high and low heating priorities; and
limiting the power consumption of heaters in each group.

2. The method for controlling the heating apparatus according to claim 1, wherein
the preparation of the groups is performed by:
determining an order of zones from the highest to lowest heating priorities; and
combining two or more zones including one having the highest heating priority or a priority close thereto and one having the lowest heating priority or a priority close thereto and repeating to combine two or more zones including one having the highest heating priority or a priority close thereto and one having the lowest heating priority or a priority close thereto among the remaining zones.

3. The method for controlling the heating apparatus according to claim 1 or 2, wherein
the heating priority is determined based on a temperature deviation between a set temperature and a present temperature of each zone.

4. The method for controlling the heating apparatus according to claim 1 or 2, wherein
the heating priority is determined by multiplying the temperature deviation between the set temperature and the present temperature of each zone by the heat capacity coefficient set for each zone.

5. The method for controlling the heating apparatus according to claim 4, wherein
the heat capacity coefficient is set greater for zones nearer inlet and outlet ports for conveying a work therethrough into and out of the furnace body, while being set smaller for zones nearer the center of the furnace body.

6. The method for controlling the heating apparatus according to claim 4, wherein
the heat capacity coefficient is set greater for zones formed below the conveyor than zones formed above the conveyor.

7. The method for controlling the heating apparatus according to claim 4, wherein
the heating priority is determined through a calculation using the adjacency coefficient that is set based on the adjacency relationship between side-to-side and above-to-below adjacent zones.

8. The method for controlling the heating apparatus according to claim 1 or 2, wherein
the preparation of the groups is modified automatically with at least one of either the change in temperature in each zone or the passage of time.

9. The method for controlling the heating apparatus according to claim 1 or 2, wherein
the power consumption of the heaters is limited by controlling heaters exclusively on and off in a plurality of zones in each group.

10. The method for controlling the heating apparatus according to claim 1 or 2, wherein
the power consumption of the heaters is limited by controlling the output of heaters to be 100% in total in a plurality of zones in each group.
